(19) United States
(12) Patent Application Publication
(10) Pub. No.: US 2014/0319135 A1
(43) Pub. Date: Oct. 30, 2014

(54) CLOSURE

(71) Applicant: Obrist Closures Switzerland GmbH, Reinach (CH)

(72) Inventor: Jamie Fox, Norwich (GB)

(73) Assignee: Obrist Closures Switzerland GmbH, Reinach (CH)

(21) Appl. No.: 14/280,531

(22) Filed: May 16, 2014

Related U.S. Application Data
(63) Continuation-in-part of application No. 13/643,946, filed on Oct. 26, 2012, now abandoned.

(30) Foreign Application Priority Data
Jun. 4, 2010 (GB) 1009427.4

(51) Int. Cl. B65D 17/00; B29D 99/00

(52) U.S. Cl. CPC B65D 17/16; B29D 99/0096; B29K 2101/12
USPC 220/202; 264/242

(57) ABSTRACT

A self-piercing closure for a container includes a laminar closing member, a closure body, and a piercing member for piercing a closing member. After piercing of the closing member, a self-closing valve of the closure dispenses flowable media from the container. In some examples, the piercing member is formed separately from the closure body, and is attachable to the closure body. The closure body may include a deformable region, and deformation of the deformable region may allow the closure body to move from a first position to a second position. Movement of the closure body from the first position to the second position may activate the piercing means.

### CROSS-REFERENCE TO RELATED APPLICATIONS

The present application is a continuation-in-part of U.S. patent application Ser. No. 13/643,946, “SELF-PIERCING CLOSURE WITH A SELF-CLOSING VALVE,” filed Oct. 26, 2012, which is the U.S. National Phase application corresponding to International PCT Application Serial No. PCT/GB2011/000648, “SELF-PIERCING CLOSURE WITH A SELF-CLOSING VALVE,” filed Apr. 26, 2011, which claims priority to Great Britain Application No. 1009427.4, filed Jun. 4, 2010, the entire contents of each of which are hereby incorporated by reference for all purposes.

### BACKGROUND AND SUMMARY

The present invention relates generally to a closure and particularly to a self-piercing closure suitable for use in conjunction with a container of the type having a laminar closing member such as a foil panel which must be breached in order to gain access to the contents of the container.

Containers which are used for holding and dispensing food products, such as ketchup, often have foil membranes affixed over the mouth of the container.

It is known to provide self-piercing closures which include some means of breaching a laminar closing member, such as a cutting or piercing member which forms part of the closure and is suitable to cut or pierce the closing member. For example, EP1234778 describes a closure which pierces and cuts a panel out of the closing member and also lifts and retains it in the closure. However, existing closures do not have the ability to regulate and control the flow of product subsequently leaving the container through the breached closing member.

The present invention seeks to address the above problems with known self-piercing closures.

According to a first aspect of the present invention there is provided a self-piercing closure for a container of a type having a laminar closing member, the closure comprising a closure body and having piercing means for piercing a closing member in use, the closure further comprising a self-closing valve for dispensing flowable media from a container following piercing of the closing member is use.

The first aspect of the present invention therefore combines a valve into a self-piercing closure arrangement so that once the laminar closing member is breached the flow of product from the container is under the control of the self-closing valve which has benefits including smooth product flow and prevention of leakage.

The term “piercing means” is intended to cover any mechanism for penetrating the laminar closure member including cutting, piercing, slicing, tearing, punching and the like.

The closure may comprise a piercing member for providing the piercing means. The piercing member may be provided as an integral part of the closure body or may be provided as a separate component which is attachable to the closure body.

The piercing member may be formed separately from and be attachable to the closure body. For example the member may be formed as a separate insert which can be clipped or otherwise connected into the body, for example from ‘underneath’. In some embodiments the member is formed as an annular cutting wheel which snap-fits into the body and carries a plurality of cutting teeth projecting at one end.

The piercing member may therefore service the dual functions of clipping the valve into place and carrying cutting/piercing means.

The piercing member may retain or help to retain the self-closing valve in the closure. For example, the self-closing valve may be assembled into the main closure body and then the piercing member is fitted into the closure body in such a way that it retains the self-closing valve.

The piercing member may comprise engagement means for attaching to the body. For example the member and body may be provided with co-operating snap-fit engagement means (such as snap beads).

The closure may be movable from a first position to a second position to activate the piercing means. For example, a push button or a bistable support part may be used.

The closure body may comprise a deformable region for allowing it to move from the first to the second position as it is activated. The deformable region may be thinned to assist movement. The deformation may be achieved by a ‘rolling’ action in which part of the body turns in on itself, for example moving from an L-shape to a U-shape.

The closure may be formed in the second position and moved to the first position prior to activation. For example, if the closure is moulded from a thermoplastics material it can be moulded in the ‘activated’ position and then moved to the non-activated initial position before it has cooled. This sets the ‘memory’ of the material to the activated position so that in use it moves more easily away from the unpierced, rest position back to the activated position.

The closure may comprise a base and a lid, which may be connected together by a hinge such as a snap hinge. Such flip-top closures are increasingly common.

The piercing means may be carried on or by the base and similarly the self-closing valve may be carried on or by the base.

According to a second aspect there is provided a self-piercing closure for a container of the type having a laminar closing member, the closure comprising a closure body and having a piercing member for piercing a closing member in use, in which the piercing member comprises a depending skirt, and in which the closure further comprising a self-closing valve sub-assembly having a retaining member which retains a self-closing valve, the sub-assembly being located within the piercing member, whereby flowable media can be dispensed from a container through the self-closing valve following piercing of the closing member in use.

Once piercing been carried out the user can then squeeze the container and force the product through the valve and an associated spout or orifice situated in the closure.

As in the first aspect of the present invention, the term “piercing” is intended to cover any mechanism for penetrating the laminar closure member including cutting, piercing, slicing, tearing, punching and the like. The piercing member may therefore, for example, comprise cutting, piercing, slicing, breaking, rupturing, bursting or splitting means.

The closure body may be movable from a first position to a second position to activate the piercing member in use.

The body may include a spout movable from a raised, unactivated position to a depressed, activated position to move the closure from the first to the second position.

The closure body may comprise a deformable region for allowing it to move from the first to the second position. The deformable region may form part of the body or may be formed separately from the body and be integrated therein, for example, using a sequential moulding process.

The closure may be formed in the second position or in a position intermediate the first and second positions, and is moved to the first position prior to activation of the piercing member in use.

The closure may be movable from a first position to a second position to activate the piercing means. For example, a push button or a bistable support part, panel, sleeve or the like may be used.

The deformable region may be thinned to assist movement. The deformation may be achieved by a ‘rolling’ action in which part of the body turns in on itself, for example moving from an L-shape to a U-shape.

The closure may be formed in the second position or in a position intermediate the first and second positions, and then moved to the first position prior to activation. For example, if the closure is moulded from a thermoplastics material it can be moulded in the ‘activated’ position and then moved to the non-activated initial position before it has cooled. This sets the ‘memory’ of the material to the activated position so that in use it moves more easily away from the unpierced, rest position back to the activated position.

As in the first aspect of the present invention, the closure according to the second aspect may comprise a base and a lid. The base and lid may be connected together by a hinge. The piercing member may be provided on or by the base.

The self-closing valve sub-assembly of the second aspect of the present invention may be formed separately from the closure and also from the container.

The retaining member of the self-closing valve sub-assembly may comprise a body for receiving a self-closing valve, the body being receivable into the piercing member with the valve retained.

The valve may be retained in the retaining member by being crimped in place. Alternatively or additionally, for example, the valve may be retained in the retaining member by being glued in place.

The retaining member body may have a crimping flange capable of being bent from an uncrimped position to a crimped position to retain the valve in the device. The crimping flange may comprise an upstanding wall.

The retaining member may comprise a circular upstanding wall and the crimping flange may comprise a circumferentially upstanding wall.

The crimping flange may be adapted to engage a flange of a valve.

The retaining member may comprise a bead for snap-fitting the sub-assembly into the piercing member.

The retaining member may be formed as a retaining ring.

The retaining member may be formed as a single-piece article.

The sub-assembly may be retained within the closure by means of a mechanical and/or a chemical fit. Alternatively or additionally the sub-assembly may be snap-fittable into the closure. For example the retaining member and/or closure body may comprise a bead for snap-fitting the device into the closure.

The retaining member may comprise a sloping surface for receiving a self-closing valve flange.

The retaining member may be formed as a retaining ring. The retaining member may, for example, be formed as a single-piece article.

The valve may be a non-laminar self-closing valve.

In one example, the valve may be formed from a thermoplastic vulcanisate (TPV) material.

In another example, the valve may be formed from a thermoplastic elastomer (TPE) material.

In yet another example, the valve may be formed from a rubber material, such as nitryl rubber.

Combinations of different materials are possible. Bi-injected valves are possible.

The self-closing valve may comprise a flange, and the rigidity of the flange may be increased by the device.

The closure body may comprise an outer skirt and an inner skirt. The piercing member may be provided within the inner skirt. For example the piercing member may be formed as a piercing skirt.

The inner skirt may include formations for engaging a container neck, such as a screw thread and/or a snap bead.

The second aspect of the present invention also provides a method of forming a self-piercing closure such as a closure in accordance with the second aspect described herein, the method comprising the steps of: forming the closure body in the second position or in a position intermediate the first and second positions; and moving the closure body to the first position.

The method may further comprise the step of fitting a self-closing valve sub-assembly into the body.

The body is moulded from a thermoplastics material. The body may be moulded in the activated position and then moved to the unactivated position before it has cooled.

The second aspect of the present invention combines a valve into a self-piercing closure arrangement so that once the laminar closing member is breached the flow of product from the container is under the control of the self-closing valve which has benefits including smooth product flow and prevention of leakage.

The piercing member may be provided as an integral part of the closure body or may be provided as a separate component which is attachable to the closure body. In some embodiments the piercing member is bi-injection moulded with the remainder of the body.

The piercing member may be formed separately from and be attachable to the closure body. For example the member may be formed as a separate insert which can be clipped or otherwise connected into the body.

As in the first aspect of the present invention, the closure according to the second aspect of the present invention may be formed so that the closure does not have to be removed in order to pierce the closing member. Further, as in the first aspect of the present invention, the closure according to the second aspect of the present invention may comprise a base and a lid, which may be connected together by a hinge such as a snap hinge.

In accordance with the second aspect of the present invention, the piercing means may be carried on or by the base and similarly the self-closing valve may be carried on or by the base.

Valves according to either aspect of the present invention may be formed from silicon or a silicon-based material.

The second aspect of the present invention also provides a closure fitted with a self-closing valve assembly as described herein.

According to a further aspect of the present invention there is provided a container having a closure as described herein (e.g., a closure in accordance with either the first aspect or the second aspect of the present invention).

The first and second aspects of the present invention also provides for a method of forming a closure comprising a body having a piercing member and a self-closing valve (e.g., a closure in accordance with either the first aspect or second aspect of the present invention described above), the method comprising the steps of: forming the closure in a depressed, activated position, and moving the closure from the activated position to a raised, unactivated position prior to activation of the closure, wherein, after the closure is attached to a container having a laminar closing member, the piercing member pierces the closing member in the activated position of the closure. The step of forming the closure may comprise moulding the body from a thermoplastics material. Further, the step of forming the closure in the activated position may comprise moulding the body in the activated position, and the step of moving the closure from the activated position to the unactivated position may comprise moving the closure from the activated position to the unactivated position before it has cooled. In the context of the second aspect of the present invention, the method may further comprise the step of fitting a self-closing valve sub-assembly into the body.

Different aspects and embodiments of the invention may be used separately or together. Further particular and preferred aspects of the present invention are set out in the accompanying independent and dependent claims. Features of the dependent claims may be combined with the features of the independent claims as appropriate, and in combination other than those explicitly set out in the claims.

### BRIEF DESCRIPTION OF THE DRAWINGS

The present invention will now be more particularly described, by way of example, with reference to the accompanying drawings, in which:

FIG. 1 is a section of a closure formed according to a first embodiment of the present invention;

FIG. 2 is a perspective view of a piercing member forming part of the closure of FIG. 1;

FIG. 3 is a section of a closure formed according to an alternative configuration of the first embodiment;

FIG. 4 is a perspective underplan view of part of the closure of FIG. 3;

FIG. 5 shows a section of part of the closure of FIGS. 3 and 4 with a bistable neck region shown in a second, activated position;

FIG. 6 is a section of the closure part of FIG. 5 with the neck region shown in a first, unactivated position;

FIG. 7 is a section of a closure formed according to a second embodiment of the present invention and shown in an as-moulded position;

FIG. 8 is a section illustrating the piercing mechanism of the closure of FIG. 7;

FIG. 9 shows a closure formed according to an alternative configuration of the second embodiment;

FIG. 10 is a perspective view of a retaining member suitable for use with the closures of FIGS. 7 to 9;

FIG. 11 is a section of the member of FIG. 10 shown fitted with a valve and prior to retention;

FIG. 12 is a perspective view of the sub-assembly of FIG. 11 following retention of the valve in the member; and

FIG. 13 is a section of the sub-assembly of FIG. 12.

### DETAILED DESCRIPTION

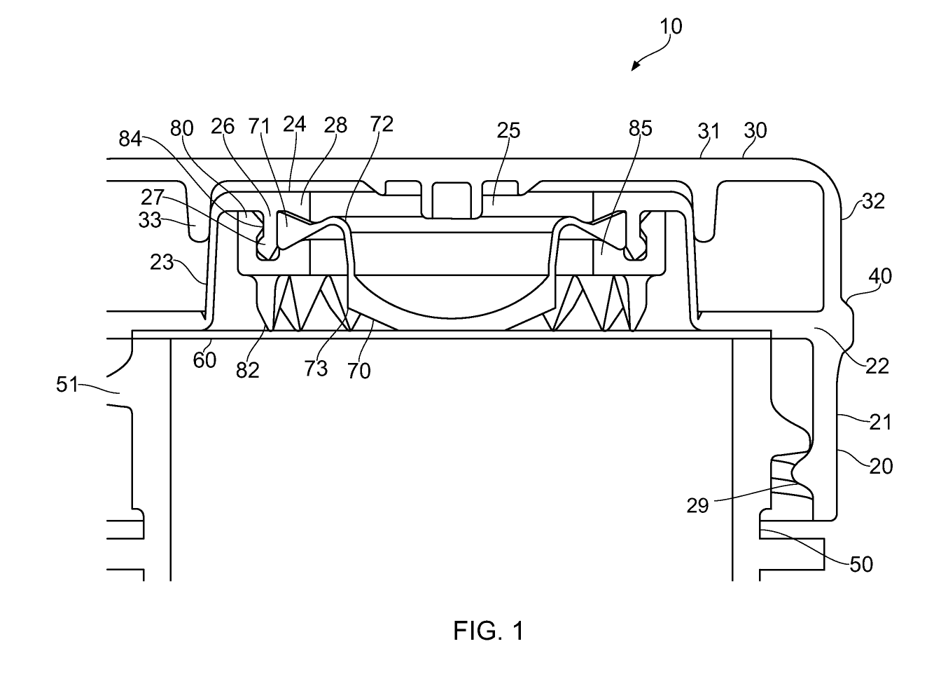

Referring first to FIG. 1 there is shown a closure generally indicated at 10. The closure 10 comprises a body including a generally cylindrical base 20 and a lid 30 connected to each other by a hinge 40.

The closure 10 is shown fitted to a container neck 50 which at its open end is sealed by a laminar foil panel 60 which in this embodiment has been heat sealed into position.

The base 20 comprises a cylindrical sidewall 21 which includes internal screwthread formations 29 for engaging corresponding external screwthread formations 51 on the container neck 50.

At the end of the sidewall adjacent the lid 30, a platform 22 extends radially inwardly. From the inner edge of the platform 22 an upstanding collar or neck 23 is provided which forms a chimney-like spout. At the opposite end of the collar 23 to the platform 22 a sealing portion 24 extends radially inwardly and defines at its centre an aperture 25. Approximately half way along the portion 24 an annular sealing leg 26 depends and terminates with a sealing bead 27. The portion 24 terminates with a wedge-shape portion 28 which includes a downwardly depending section.

A self-closing valve 70 is provided. The valve 70 is of standard construction and briefly comprises a generally triangular section support ring 71, a J-shape connecting wall 72 and a generally disc-shape concave valve head 73.

The valve 70 is fitted into the base 20 so that the ring 71 abuts against the portion 28 and the opposingly inclined surfaces allow for a stable interaction.

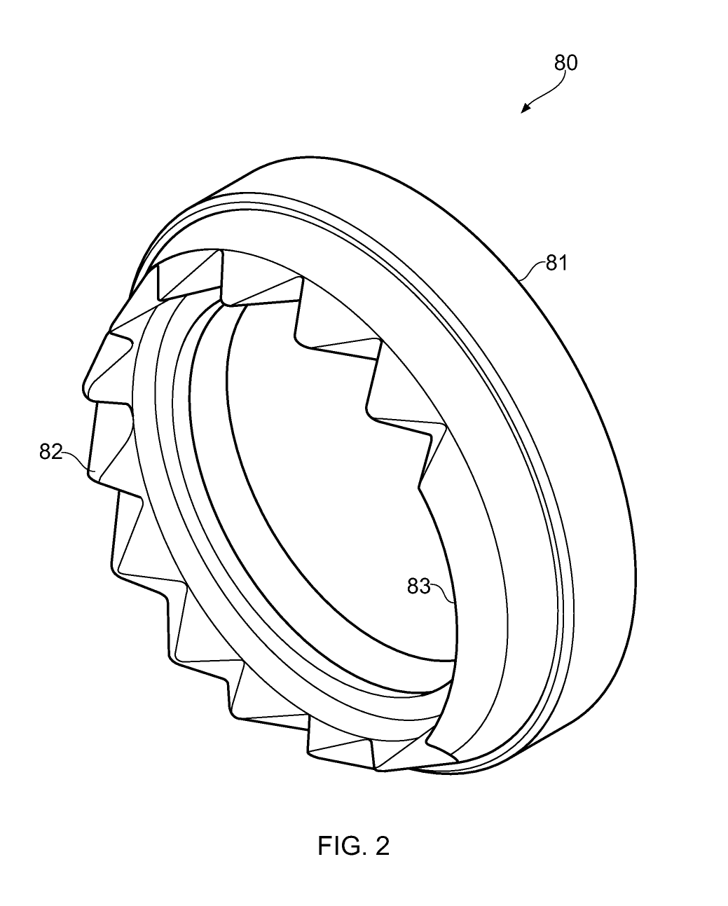

Referring now also to FIG. 2 a piercing member 80 is provided.

The member 80 is generally annular and comprises a retention band 81 from which depends a cutting region comprising a plurality of teeth 82 and a single arcuate blade 83. At the end of the band 81 opposite the teeth 82 a bead 84 projects radially inwardly. Extending parallel to the band 81 on the opposite side of the teeth 82 is a retention jaw 85. In use, with the self-closing valve assembled into the base, the member 80 is snap fitted on to the base so that the bead 84 clips over the bead 27. At the same time, the jaw 85 engages the ring 71 so that it is held firmly between the portion 28 and the jaw 85. For this purpose the jaw 85 includes an inclined surface oppositely inclined to that side of the ring 71.

The lid 30 comprises a generally disc-shape top plate 31 from which depends a cylindrical sidewall 32. A cylindrical bead 33 depends from the underside of the top plate 31 and is positioned to engage around the neck 23 to provide at least an initial seal.

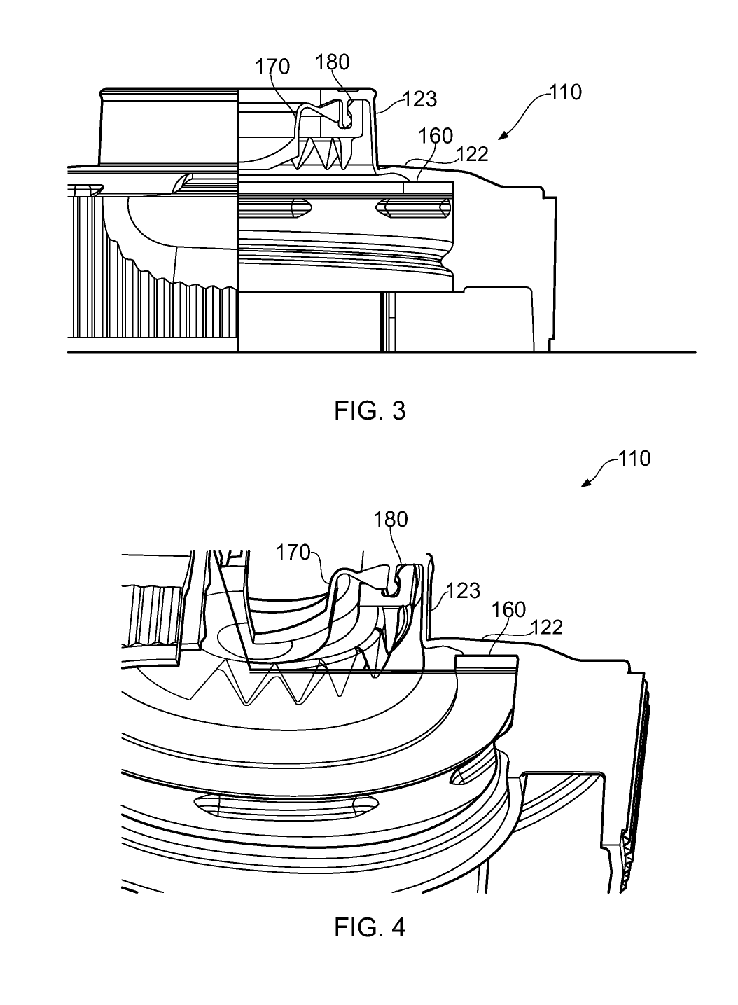

Referring now to FIGS. 3 and 4 a closure 110 formed according to an alternative embodiment is shown. The closure 110 is very similar to the closure 10, and includes a self-closing valve 170 and a piercing member 180. In this embodiment a heat sealable liner 160 is provided and fits into the base 120 under a platform 122. In use the closure 110 is fitted onto a container neck (not shown) and induction is used to seal the liner onto the neck. Subsequently the piercing process is as described below.

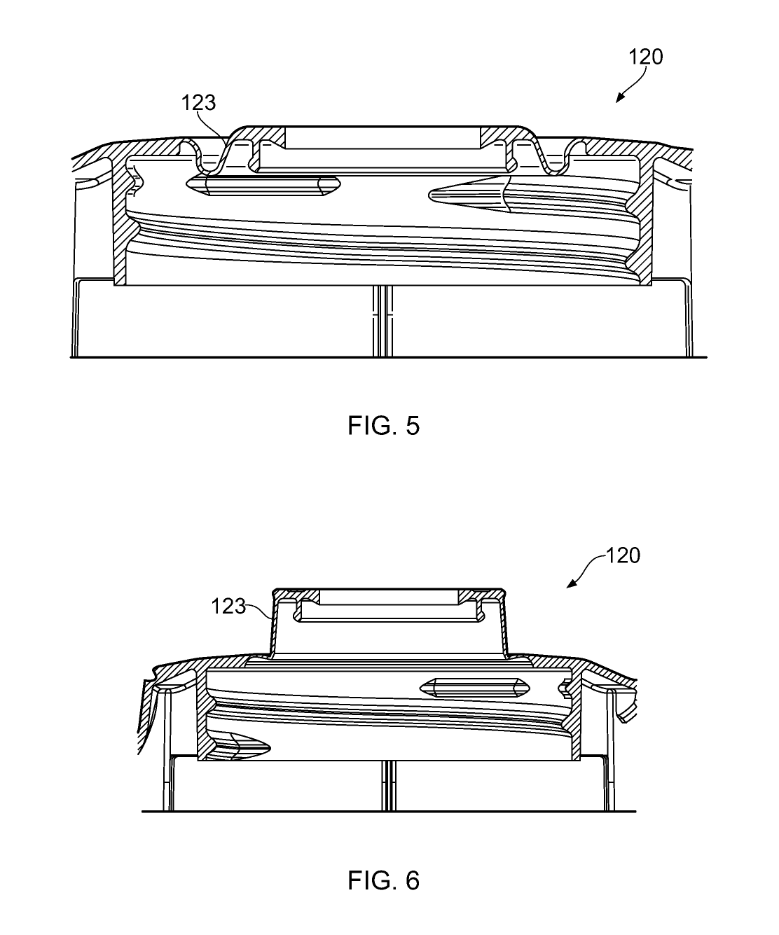

In FIGS. 5 and 6 the closure body of FIGS. 3 and 4 is shown with the liner, valve and piercing member removed for clarity. FIG. 5 shows the closure in an as-moulded condition in which a neck 123 is depressed and represents an activated position. FIG. 6 shows the closure in a resting or unactivated position which in use would be how the closure would be provided on a product.

By moulding the closure in the activated position it can be pushed out before final cooling to the unactivated position, but the ‘memory’ of the material will be set to the activated position. This makes subsequent movement from the unactivated to the activated position much easier.

In the activated position the neck 123 adopts a generally U-shape configuration and in the unactivated position it adopts a generally L-shape configuration.

In use the neck 123 is pushed down, which carries with it the piercing member 180 and the valve 170. The piercing member will pierce the seal, allowing product from a container to flow through the valve.

In some embodiments it may be necessary for a degree of relative rotation of the closure with respect to the panel to be employed in order to result in a satisfactory breaching of the panel.

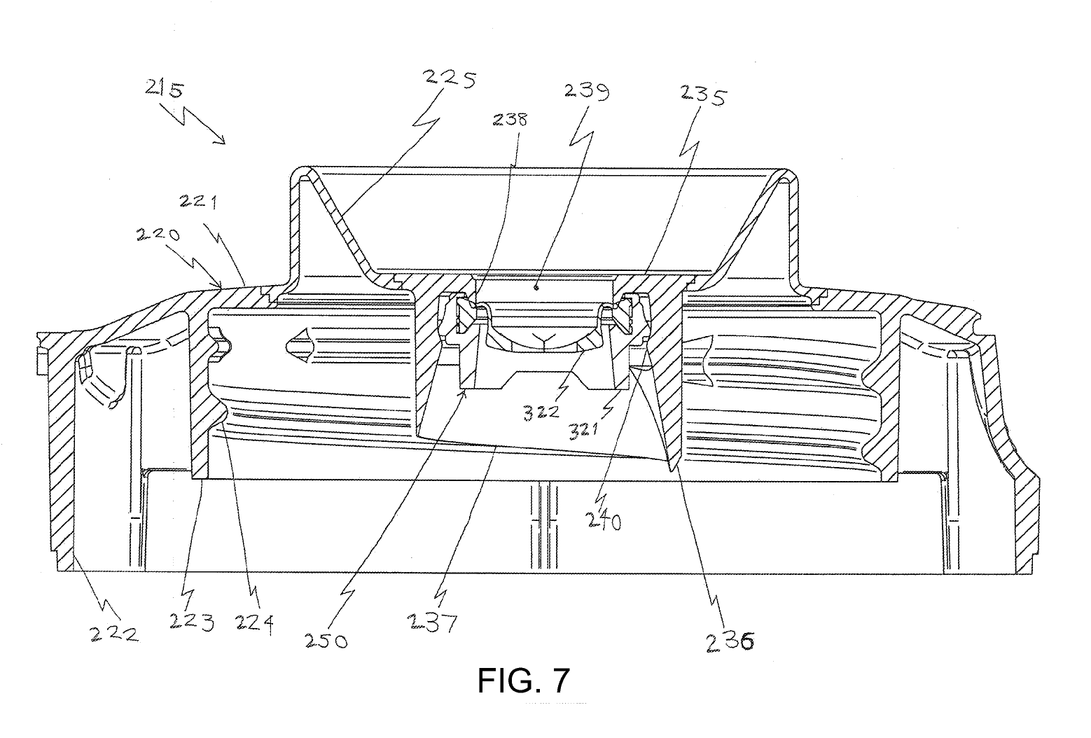

Referring now to FIG. 7 there is shown a closure generally indicated at 215. The closure 215 comprises a body including a generally cylindrical base 220.

The closure 215 is fittable to a container neck (not shown) which at its open end is sealed by a laminar foil panel.

The base 220 comprises a top deck 221 from which depends a generally cylindrical outer sidewall 222 and a generally cylindrical inner sidewall 223 which includes internal screwthread formations 224 for engaging corresponding external screwthread formations on the container neck.

At the centre of the top deck 221 a deformable spout 225 is provided. At the centre of the spout 225 a piercing member 235 is provided.

FIG. 7 shows the closure in a post-moulding state, in which the spout 225 is in a fully depressed position and forms an inclined annulus.

The piercing member 235 comprises an annular piercing skirt 236 which depends from the spout and the free end of which is inclined to form a cutting blade 237. A retention bead 240 is formed on the inner surface of the piercing skirt 236.

At the end of the skirt opposite the blade a claw-like annulus 238 extends radially inwards and defines a dispensing orifice 239 at its centre.

In addition, a self-closing valve sub-assembly 250 is fitted into the piercing member 235, further details of which are given below.

By moulding the closure in the activated, or as in this embodiment in a position intermediate the activated and unactivated positions, it can be moved before final cooling to the unactivated position, but the ‘memory’ of the material will be set to the activated position. This makes subsequent movement from the unactivated to the activated position much easier.

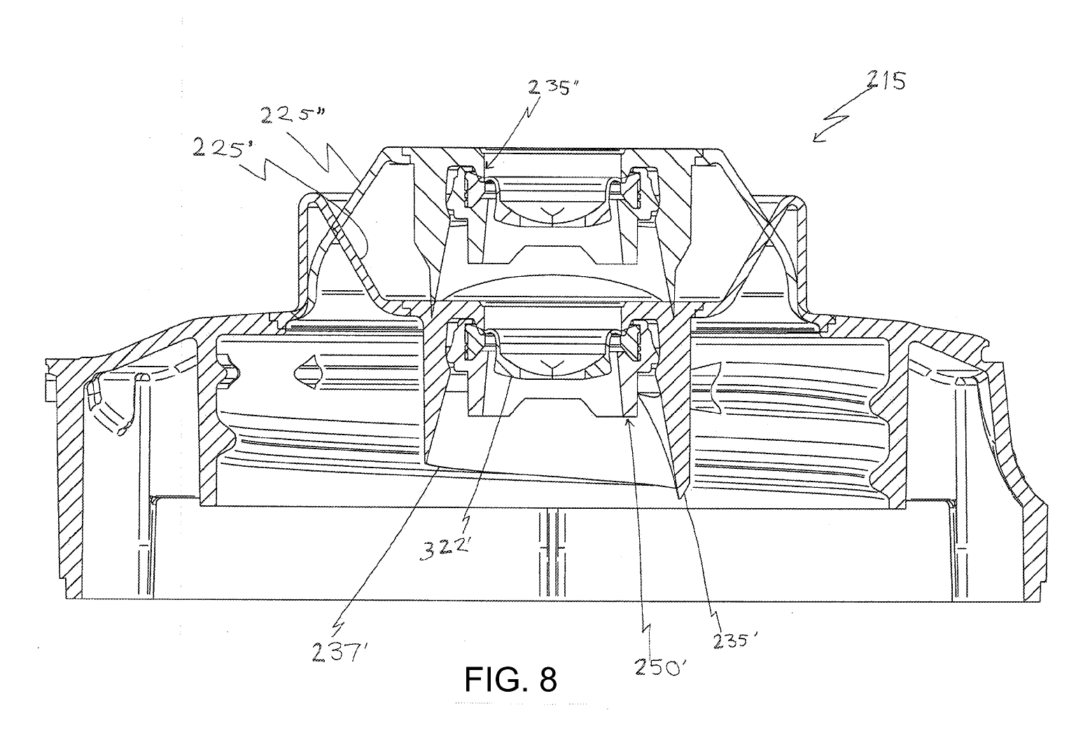

FIG. 8 shows both the raised, unactivated (which in use would be how the closure would be provided on a product) and depressed, activated positions of the closure. For illustrative purposes, parts of the closure in the depressed, activated position are labelled with prime symbols after each reference numeral (e.g., 225′, 237′, 322′, 250′, and 235′), whereas parts of the closure in the raised, unactivated position are labelled with double prime symbols after each reference numeral (e.g., 225″, 235″). In use, the spout 225 is pushed down, carrying with it the piercing member 235 and the valve sub-assembly 250. The piercing member blade 237 will pierce the seal, allowing product from a container to flow through the valve 322.

In this embodiment, in the activated position the spout wall 225′ is inclined towards the body and in the unactivated position the spout wall 225″ is inclined away from the body.

In some embodiments it may be necessary for a degree of relative rotation of the closure with respect to the panel to be employed in order to result in a satisfactory breaching of the panel.

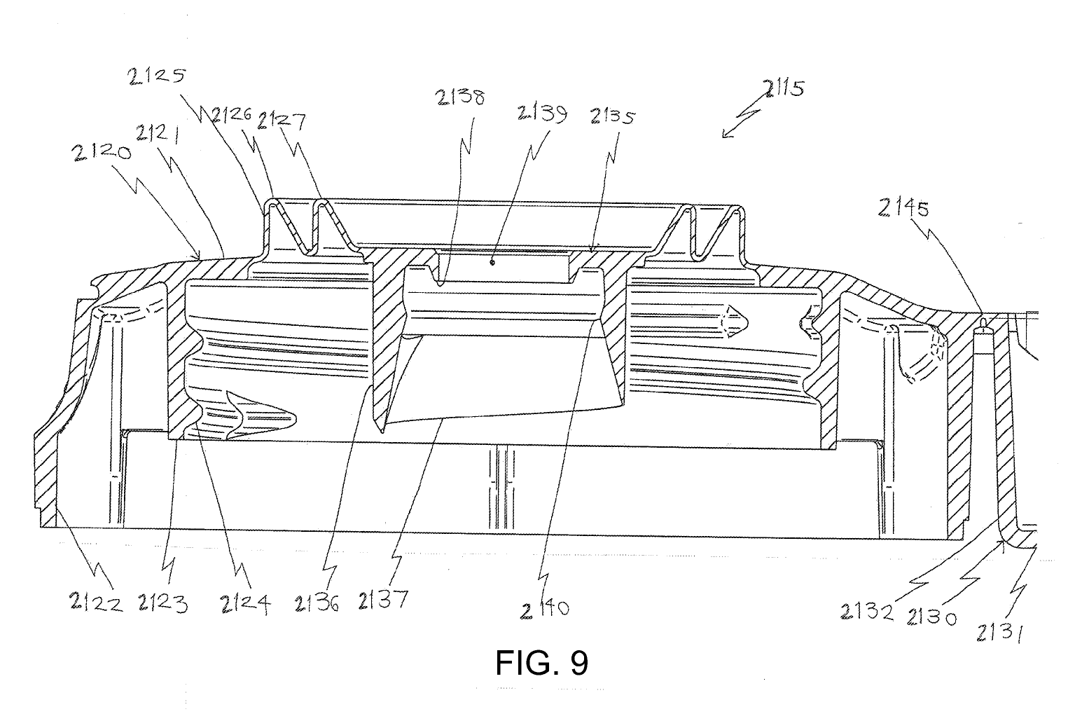

FIG. 9 shows a closure 2115 including a flexible spout 2125 formed according to an alternative embodiment. The spout 2125 is shown in its moulded (down) position prior to pre-setting. In this configuration the spout has a generally corrugated form with two annular folds 2126, 2127. To pre-set the closure the spout is pushed up to an unactivated position. In other embodiments (not shown) annular folds are alternatively or additionally present in the spout wall in activated, unactivated or intermediate positions. For the sake of brevity, features of FIG. 9 corresponding to features already described above with respect to FIGS. 7 and 8 will not be described again (e.g., base 2120, outer sidewall 2122, inner sidewall 2123, internal screwthread formations 2124, piercing skirt 2136, cutting blade 2137, retention bead 2140, claw-like annulus 2138, dispensing orifice 2139, piercing member 2135, etc.)

FIG. 9 also shows a lid 2130 (only part of which is shown) connected to a base 2120 by a hinge 2145. The lid 2130 comprises a generally disc-shape top plate 2131 from which depends a cylindrical sidewall 2132.

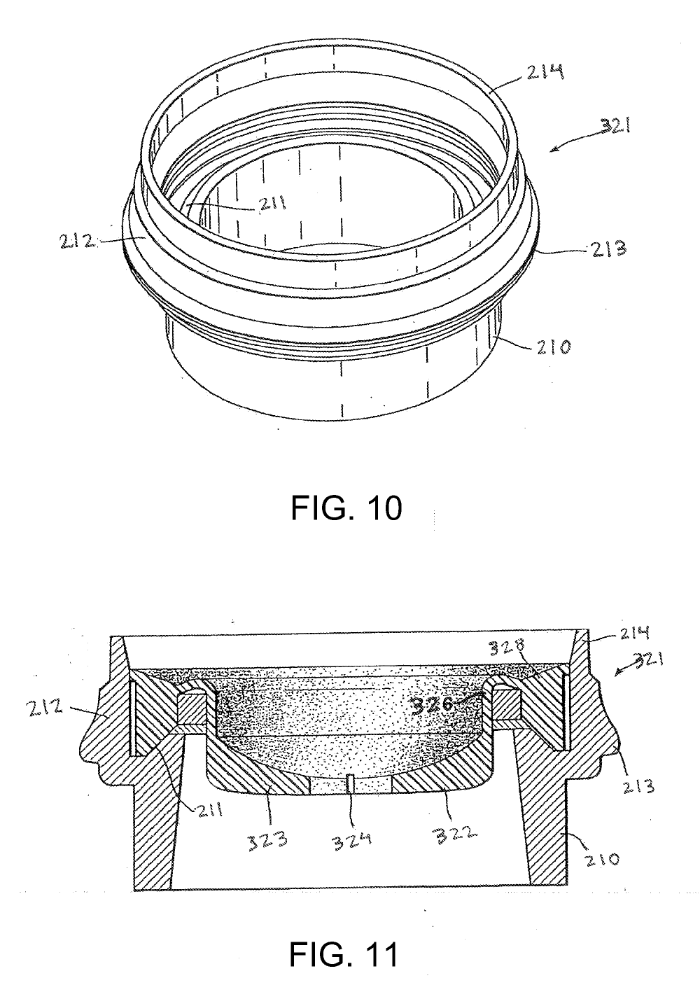

Referring now to FIG. 10 there is shown a retaining member 321, which shall be referred to hereinafter as a retaining ring 321. The ring 321 consists of a moulded single-piece article/body with a so-called “chimney” in the form of a circular wall 210. This chimney 210 provides a surface for assembly machinery to handle the retaining ring 321. At the outer radial end of the chimney wall 210 another circular wall 212, which has the same rotational axis as chimney 210, extends upwards. This end of the wall 210 also includes an inner ring that forms a seat.

Along the circumference of the radially outer surface of wall 212 is a projection in the form of an external sealing bead 213. At the end of wall 212 is a crimping flange 214 which in its uncrimped condition is an upstanding wall.

A flexible self-closing valve 322 may have the features shown in FIG. 11. For instance, such a valve 322 may have a head portion 323, which is thicker towards the edge than the centre and which has at least one slit 324 therein. The head portion may be concave with respect to a container (not shown) to which the closure is attached. This may pre-stress the valve so that it self-closes more easily.

A side-wall or connecting wall portion 326 connects the head portion 323 with a flange 328. Flange 328 is typically shaped such that it has a relatively substantial size in the form of a rim. It is this flange 328 which rests on the inner ring and sits in the seat of the retaining ring 321 when it is located correctly. This forms a self-closing valve sub-assembly 250 that can easily be manipulated.

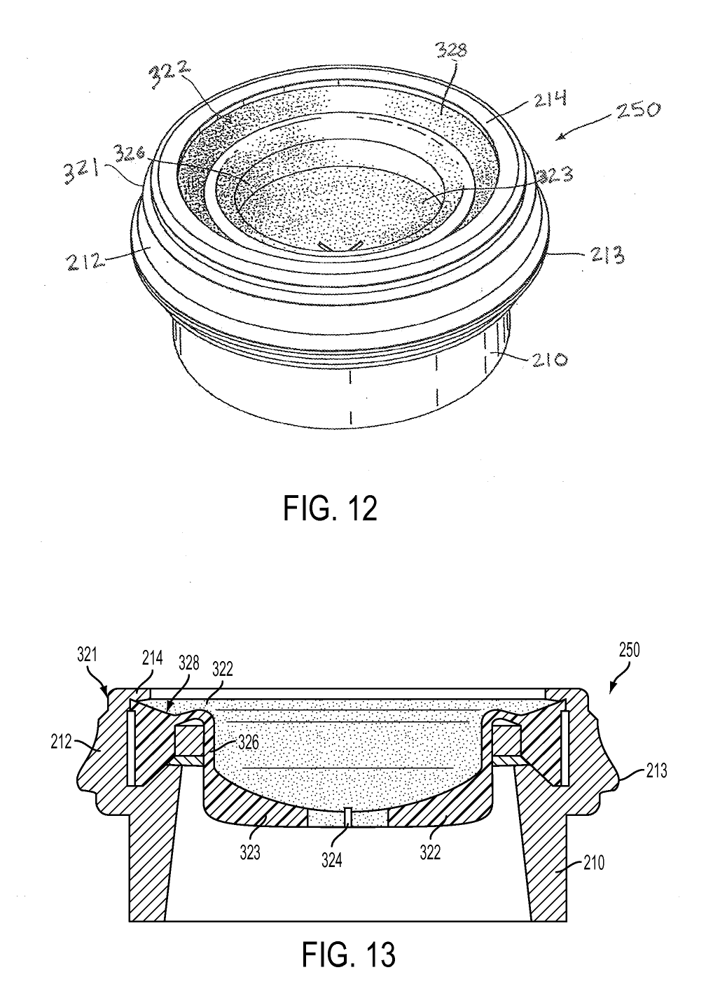

In this embodiment, to crimp the valve 322 in place, the crimping flange 214 is bent over from the position shown in FIGS. 10 and 11 until it sandwiches the flange 328 between itself (214) and the sloping surface 211 as shown in FIGS. 12 and 13.

Although in this embodiment the crimping flange 214 is shown as being bent over by 90 degrees radially inwards it should be understood that the angle through which it need be bent is not fixed and may be another angle.

The sub-assembly 250 can be fitted into a closure. In some embodiments, for example, the assembly 250 is fitted into a movable section of closure (such a spout section) and then moved together with that section to cause a liner to be pierced. In the case of the closure of FIGS. 7 to 9, for example, the sub-assembly 250 is fitted into the piercing member 235 by engagement of the beads 213, 240, with the upper part of the assembly fitting up into and being retained by the claw-like annulus 238.

Although illustrative embodiments of the invention have been disclosed in detail herein, with reference to the accompanying drawings, it is understood that the invention is not limited to the precise embodiments shown and that various changes and modifications can be effected therein by one skilled in the art without departing from the scope of the invention as defined by the appended claims and their equivalents.

1. A self-piercing closure for a container having a laminar closing member, the closure comprising a closure body including a base and a lid, a piercing member for piercing the closing member, and a self-closing valve for dispensing flowable media from the container following piercing of the closing member, the closure movable from a first unactivated position to a second activated position, the piercing member piercing the closing member in the second position, wherein the closure is formed in the second position and is moved to the first position prior to activation.

2. The closure as claimed in claim 1, wherein the closure body comprises a thinned deformable region for allowing it to move from the first to the second position, and wherein deformation of the deformable region is achieved by a rolling action.

3. The closure as claimed in claim 1, wherein the self-closing valve comprises a support ring which abuts against a portion of the base, the piercing member formed separately from and attachable to the closure body, and the piercing member retaining the self-closing valve in the closure.

4. The closure as claimed in claim 1, wherein the base comprises a chimney-like spout including a sealing portion extending radially inwardly, and wherein the portion of the base which the support ring abuts against is a wedge-shape portion of the sealing portion.

5. A method of forming a closure comprising a body having a piercing member and a self-closing valve, comprising:
forming the closure in a depressed, activated position; and
moving the closure from the activated position to a raised, unactivated position prior to activation of the closure;
wherein, after the closure is attached to a container having a laminar closing member, the piercing member pierces the closing member in the activated position of the closure.

6. The method as claimed in claim 5, wherein forming the closure comprises moulding the body from a thermoplastics material.

7. The method as claimed in claim 5, wherein forming the closure in the activated position comprises moulding the body in the activated position, and wherein moving the closure from the activated position to the unactivated position comprises moving the closure from the activated position to the unactivated position before it has cooled.

8. The method as claimed in claim 5, further comprising the step of fitting a self-closing valve sub-assembly into the body.

9. A self-piercing closure for a container having a laminar closing member, the closure comprising a closure body, a piercing member for piercing the closing member, and a self-closing valve sub-assembly, wherein the piercing member comprises a depending skirt, wherein the self-closing valve sub-assembly has a retaining member which retains a self-closing valve and is located within the piercing member, and wherein flowable media can be dispensed from a container through the self-closing valve following piercing of the closing member.

10. The closure as claimed in claim 9, wherein the body includes a spout movable from a raised, unactivated position to a depressed, activated position to move the closure from the first position to the second position.

11. The closure as claimed in claim 9, wherein the body comprises a deformable region for allowing it to move from the first to the second position.

12. The closure as claimed in claim 9, wherein the closure comprises a base and a lid connected together by a hinge, and wherein the piercing member is provided on or by the base.

13. The closure as claimed in claim 9, wherein the body is movable between a first unactivated position and a second activated position, wherein the body is formed in either the second position or a position intermediate the first and second positions, wherein the body is moved to the first position prior to activation of the piercing member, and wherein movement of the body from the first position to the second position activates the piercing member.

14. The closure as claimed in claim 9, wherein the retaining member comprises a body for receiving a self-closing valve, the body being receivable into the piercing member with the valve retained.

15. The closure as claimed in claim 14, wherein the retaining member body has a crimping flange capable of being bent from an uncrimped position to a crimped position to retain the valve in the device, and wherein the crimping flange comprises an upstanding wall.

16. The closure as claimed in claim 9, wherein the retaining member comprises a bead for snap-fitting the device into the piercing member.

17. The closure as claimed in claim 9, wherein the retaining member is formed as a retaining ring.

18. The closure as claimed in claim 9, wherein the retaining member is formed as a single-piece article.

19. The closure as claimed in claim 9, wherein the body comprises an outer skirt and an inner skirt, wherein the piercing member is provided within the inner skirt, and wherein the inner skirt includes formations for engaging a container neck.

20. The closure as claimed in claim 9, wherein the piercing member is a piercing skirt.
